(19) United States
(12) Patent Application Publication
(10) Pub. No.: US 2026/0164484 A1
(43) Pub. Date: Jun. 11, 2026

(54) METHODS, ARCHITECTURES, APPARATUSES AND SYSTEMS FOR NETWORK ASSISTED COORDINATION FOR MULTI-STEER DEVICES

(71) Applicant: InterDigital Patent Holdings, Inc., Wilmington, DE (US)

(72) Inventors: Taimoor Abbas, Sainte-Julie (CA); Samir Ferdi, Kirkland (CA); Anuj Sethi, Ottawa (CA); Rocco Di Girolamo, Laval (CA); Guanzhou Wang, Brossard (CA); Ulises Olvera-Hernandez, Saint-Lazare (CA); Michael Starsinic, Newtown, PA (US)

(21) Appl. No.: 18/976,011

(22) Filed: Dec. 10, 2024

(51) Int. Cl. H04W 76/15; H04W 48/18; H04W 60/04

(52) U.S. Cl. CPC H04W 76/15; H04W 48/18; H04W 60/04

(57) ABSTRACT

This disclosure relates to network assisted coordination for user equipment (UE) with multi-steer capabilities (e.g., DualSteer capabilities). A node of a core network may establish a multi-steer protocol data unit (PDU) session for a first UE and a second UE. The node may include a processor configured to determine a multi-steer ID for the first UE and receive a PDU session request from the second UE indicating a multi-steer session type. The processor may be further configured to retrieve the multi-steer ID for the first UE based on receiving the PDU session request and to associate the PDU session request with a session management function (SMF) of the core network based on the multi-steer ID. The processor may be further configured to send a request to establish the multi-steer PDU session for the second UE using the SMF.

### TECHNICAL FIELD

The present disclosure is generally directed to the fields of communications, software and encoding, including, for example, to methods, architectures, apparatuses, systems related to network assisted coordination for multi-steer devices (e.g., including DualSteer devices, related devices, and any other devices capable of steering traffic through more than two communication routes).

### SUMMARY

This disclosure relates to network assisted coordination for communication devices with multi-steer capabilities (e.g., DualSteer capabilities). This disclosure may provide for network assisted coordination of multiple user equipments (UEs), of multiple wireless transmit/receive units (WTRUs), or of any combination thereof. In certain embodiments, a WTRU may include exactly one UE. In certain embodiments, a WTRU may physically include two (or more) separate UEs in one physical device. In certain embodiments, a WTRU may logically couple two (or more) separate UEs or separate WTRUs into a logical device. As referred to herein, a DualSteer device may represent a device with two UEs (or WTRUs) linked together, and a DualSteer UE (or WTRU) may represent a DualSteer capable UE (or WTRU) belonging to a DualSteer device. As referred to herein, a multi-steer device may represent a device with two or more UEs (or WTRUs) linked together and a multi-steer UE (or WTRU) may represent a multi-steer capable UE belonging to a multi-steer device. Accordingly, as used herein, a DualSteer device is an example of a multi-steer device and a DualSteer capable UE is an example of a multi-steer capable UE. A Multi-Steer Coordination Function (MSCF) may be used as a part of configuring associated multi-steer Protocol Data Unit (PDU) sessions for multi-steer devices with two or more UEs. One example of an MSCF is a DualSteer Coordination Function (DSCF), which, e.g., may describe the case of two UEs linked together. A multi-steer PDU session may be referred to herein as a DualSteer PDU session. The MSCF may be executed in the core network (CN), e.g., as its own function, as part of an existing network function (e.g., access and mobility management function (AMF), Unified Data Management (UDM), Policy Control Function (PCF), any other suitable network function, or any combination thereof), or outside the CN (e.g., in an application enablement layer domain). With respect to multi-steer context information (e.g., including but not limited to UE IDs, multi-steer IDs, WTRU IDs, Anchor IDs, common PDU session IDs, or any combination thereof), the MSCF may create, store, generate, retrieve, or maintain the information, or any combination thereof. The multi-steer context information may be specific to any multi-steer UE or WTRU. The multi-steer context information may associate, link, or otherwise connect multi-steer UEs belonging to a common multi-steer device (e.g., a multi-steer UE or multi-steer WTRU). The MSCF may coordinate how data is trafficked between respective multi-steer UEs and a network in communication with the multi-steer UEs. The MSCF may also coordinate the exchange of information between a multi-steer UE and a PDU session. For example, the PDU session may interface with the core network using one or more network functions (NFs), using one or more Public Land Mobile Networks (PLMNs), using any suitable network node, or using any combination thereof. The MSCF may locate a common anchor in an efficient manner so that the common anchor can be shared by the respective UEs of a multi-steer device. The MSCF may also manage how the respective multi-steer UEs join and leave a shared multi-steer PDU session (e.g., two associated PDU sessions). The multi-steer PDU session may enable steering, switching, and/or splitting of traffic between the UEs. As referred to herein, “associated” PDU sessions may refer to one or more PDU sessions for serving one or more UEs of a multi-steer device. For example, the one or more UEs of the multi-steer device may be are linked, associated, or otherwise connected to provide steering, switching, and/or splitting to the multi-steer device's traffic.

Compared to other approaches for managing multi-steer communications, the MSCF may provide enhanced efficiency in terms of redundancy, data throughput optimization, and load balancing in both roaming and non-roaming scenarios.

In accordance with certain embodiments of the present disclosure, methods and systems are provided for establishing a multi-steer PDU session for two or more multi-steer UEs. The establishing of the multi-steer PDU session may be performed by a core network node or a network function implemented thereon. The core network node may include at least one processor for establishing the multi-steer PDU session. The at least one processor may determine a multi-steer identification (ID) for a first multi-steer UE and receive a PDU session request from a second multi-steer UE. The session request may indicate a multi-steer session type for the second UE. The at least one processor may retrieve the multi-steer ID for the first UE based on receiving the PDU session request from the second multi-steer UE. The at least one processor may associate the PDU session request from the second multi-steer UE with a session management function (SMF) of the core network based on the multi-steer ID. The at least one processor may send a request to establish a multi-steer PDU session for the second multi-steer UE using the SMF.

In some embodiments, the at least one processor may associate the PDU session request with the SMF further based on determining whether a previously-established PDU session exists for the first multi-steer UE, wherein the previously-established PDU session was established based on the multi-steer ID. For example, the SMF may have been used in connection with the previously-established PDU session.

In some embodiments, if the previously-established PDU session exists, the at least one processor may associate the PDU session request with the SMF by associating the PDU session request with an SMF of the previously-established PDU session, wherein the SMF is the SMF of the previously-established PDU session.

In some embodiments, if the previously-established PDU session does not exists, the at least one processor may associate the PDU session request with the SMF by selecting the SMF from among a plurality of available SMFs based on the multi-steer ID.

In some embodiments, the at least one processor may determine the multi-steer ID based at least in part on at least one of a subscription identifier of a first UE or of a second UE of the WTRU, at least one rule for communicating with the first UE or the second UE, a CN function ID, a PDU session ID, or an indication of which UE, among at least the first UE and the second UE, is a primary UE.

In some embodiments, the at least one processor may determine the multi-steer ID based on attempting to retrieve the multi-steer ID from a function of the CN.

In some embodiments, the at least one processor may determine the multi-steer ID by, in response to a failed attempt to retrieve the multi-steer ID, generating the multi-steer ID for the first UE based on retrieving an ID associated with the first UE.

In some embodiments, the at least one processor may retrieve the multi-steer ID by communicating with at least one other node of the CN.

In some embodiments, the at least one processor may determine, based on the multi-steer ID, how to route information that is communicated between the first UE, the second UE, and the SMF, wherein the information includes first information from a first UE and second information from a second UE.

In some embodiments, the at least one processor may receive a registration request from the second UE, wherein the registration request further indicates the multi-steer session type of the second UE.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system, according to some embodiments of this disclosure;

FIG. 1B is a system diagram illustrating an example wireless transmit/receive unit (WTRU) that may be used within the communications system illustrated in FIG. 1A, according to some embodiments of this disclosure;

FIG. 1C is a system diagram illustrating an example radio access network (RAN) and an example core network (CN) that may be used within the communications system illustrated in FIG. 1A, according to some embodiments of this disclosure;

FIG. 1D is a system diagram illustrating a further example RAN and a further example CN that may be used within the communications system illustrated in FIG. 1A, according to some embodiments of this disclosure;

FIG. 2 is a block diagram illustrating an example of a core network node that may be used within the core network of FIGS. 1A, 1C, and 1D, according to some embodiments of this disclosure;

FIG. 3 shows an illustrative communication system including a WTRU with two respective UEs, according to some embodiments of this disclosure;

FIG. 4 shows an illustrative non-roaming multi-steer architecture, according to some embodiments of this disclosure;

FIG. 5 shows an illustrative roaming multi-steer architecture with two different VPLMNs and a common HPLMN, according to some embodiments of this disclosure;

FIG. 6 shows an illustrative roaming multi-steer architecture with two different VPLMNs and two different HPLMNs, according to some embodiments of this disclosure;

FIG. 7A is a first portion of an illustrative flow diagram of steps for establishing a multi-steer PDU session with assistance from a MSCF, according to some embodiments of this disclosure;

FIG. 7B is a second portion of an illustrative flow diagram of steps for establishing a multi-steer PDU session with assistance from a MSCF, according to some embodiments of this disclosure; and

FIG. 8 is an illustrative flow diagram of steps for network assisted coordination for multi-steer devices, according to some embodiments of this disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

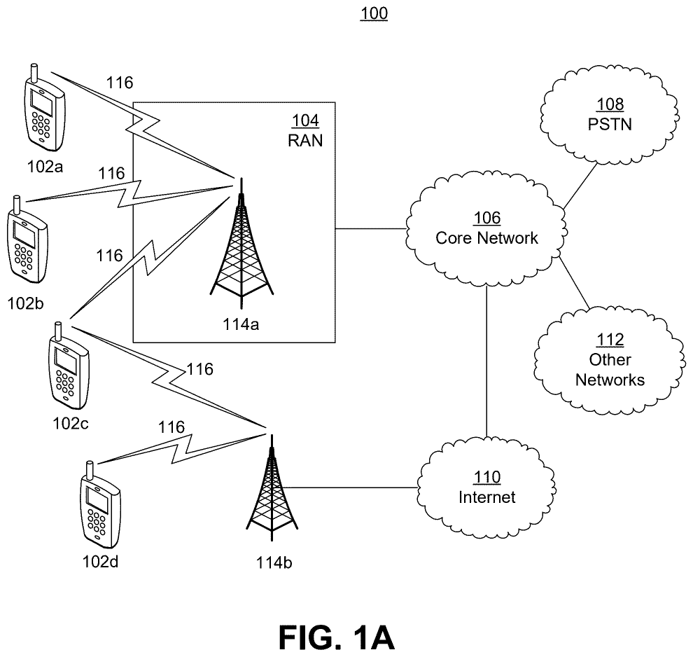

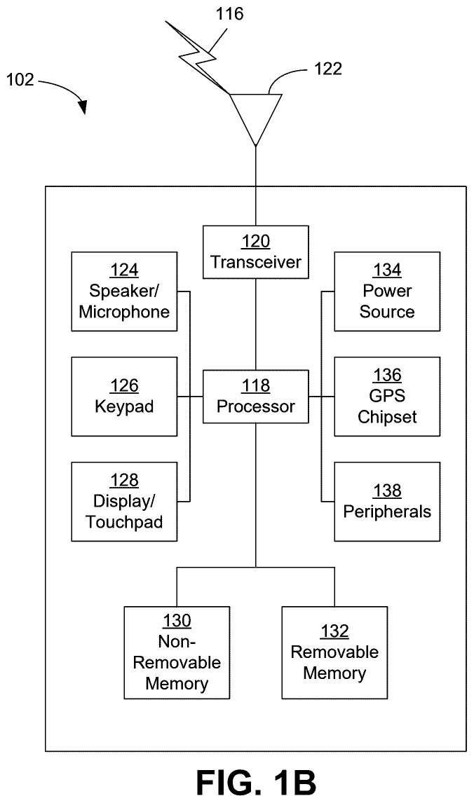

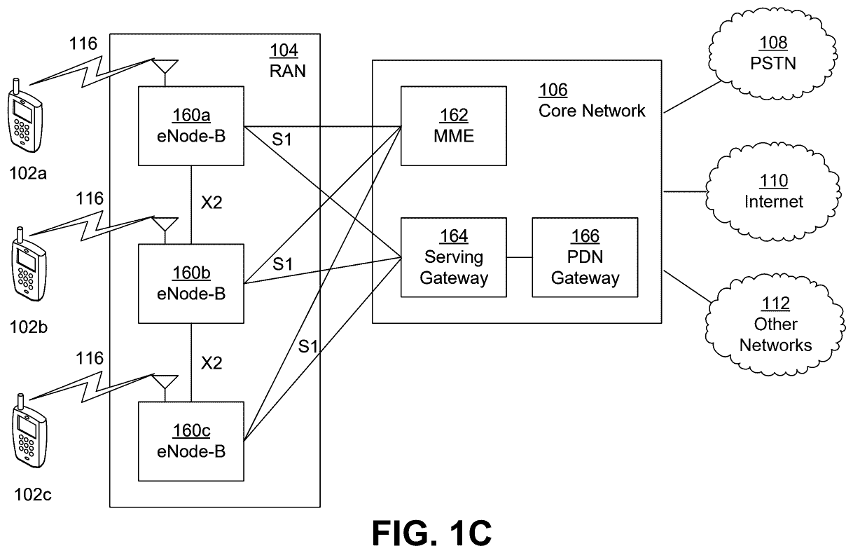

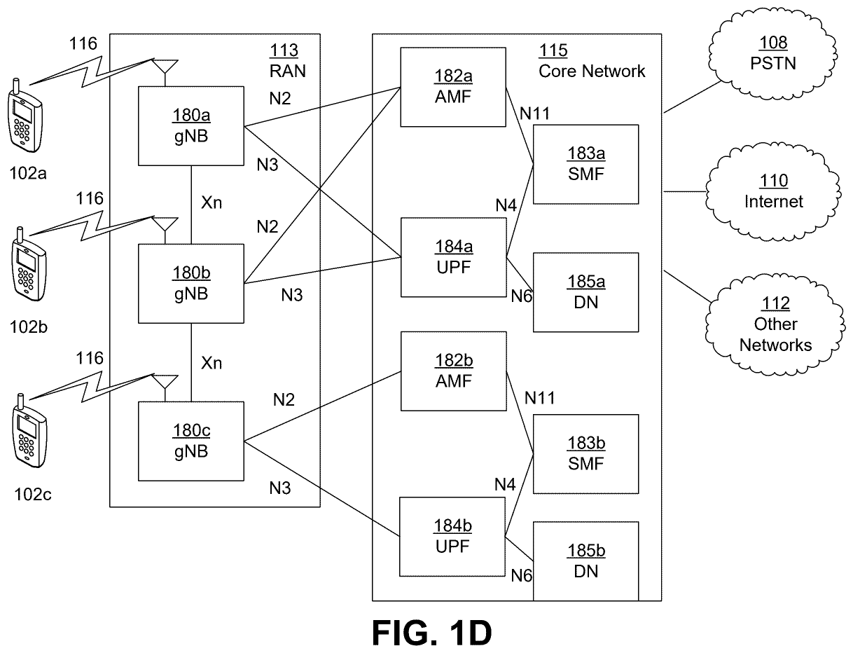

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) one or more user equipment (UE) components, a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE, e.g., if that WTRU includes only one active UE. Any of the WTRUs 102a, 102b, 102c and 102d may be interchangeably referred to as a DualSteer device if that WTRU includes two active UEs (e.g., within a single physical device, or as a logical device). Any of the WTRUs 102a, 102b, 102c and 102d may also be interchangeably referred to as a multi-steer device if that WTRU includes two or more active UEs (e.g., within a single physical device, or as a logical device). It will be understood that any description pertaining to a DualSteer device also pertains to a multi-steer device. It will also be understood that any description pertaining to a DualSteer functionality also pertains to a multi-steer functionality. A WTRU that is operating as a multi-steer device may include two or more UEs that are not physically connected or co-located, but rather are logically coupled to perform coordinated multi-steer functions (e.g., where such a WTRU may be referred to as a logical device).

In view of the aforementioned distinctions, and in some cases interchangeability, of a WTRU and a UE, certain embodiments of this disclosure may be agnostic to whether the respective components of a multi-steer device are respective WTRUs, respective UEs, or a combination thereof. For example, a DualSteer device may include two WTRUs, two UEs, or one WTRU and one UE. Likewise, information (e.g., multi-steer ID, multi-steer session type, any type of context information, any other information that may be used to establish a multi-steer network session for a multi-steer device, or any combination thereof) that may be used in certain embodiments of this disclosure toward providing for network assisted coordination may be applied to one or more respective WTRUs, to one or more respective UEs, to one or more respective DualSteer devices, to one or more respective multi-steer devices, or to any combination thereof.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite.

The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment. It will be appreciated that the WTRU 102 (e.g., as a DualSteer or multi-steer device) may include multiple iterations of any the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

As mentioned, although the transmit/receive element 122 is depicted in FIG. 1B as a single element, the WTRU 102 may include any number of transmit/receive elements 122. For example, the WTRU 102 may employ MIMO technology. Thus, in an (e.g., DualSteer device) embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers (e.g., in a DualSteer or multi-steer device embodiment) for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and/or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

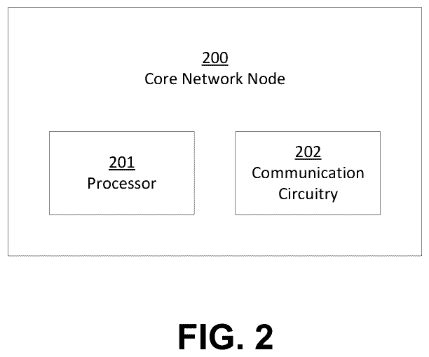

Any of the functions of CN 106 or CN 115 (e.g., AMF 182a, SMF 183a, UPF 184a, AFM 182b, SMF 183b, UPF 184b) may be implemented using one or more network nodes. FIG. 2 is a block diagram illustrating an example of a core network node 190 that may include at least one processor 191 coupled to communication circuitry 192 for implementing one or more functions of a core network, according to some embodiments of this disclosure. The core network node 190 of FIG. 2 can be part of RAN 104 or 113, a part of core network 106 or 115, a part of other networks 112, or any other suitable part (e.g., node) of a wireless network. The core network node 190 can include any suitable hardware, software, or both, for implementing the functionality of the core network node 190 as described in the present disclosure. As shown, core network node 190 may include at least one processor 191 to execute the logic of core network node 190 as described in the present disclosure. For example, the at least one processor 191 may execute logic to perform DSCF or MSCF functions for assisting coordination of multi-steer devices. Communication circuitry 192 may send and receive data between core network node 190 and any other suitable nodes or devices (e.g., between core network node 190 and one or more of WTRUs 102a, 102b, 102c, or 102d, RAN 104, other functions or nodes of CN 106 or 115, any suitable UE, any suitable base station 114, any suitable fusion device, any other device executing a function of a wireless network, or any combination thereof). It will be understood that core network node 190 may include one or more physical hardware components that may be distributed. For example, the core network node 190 may be a logical node implementing any one or more of the AMF, SMF, UPF, or MSCF. While FIG. 2 depicts the processor 191 and the communication circuitry 192 as separate components, it will be appreciated that the processor 191 and the communication circuitry 192 may be integrated together, e.g., in an electronic package or chip, or distributed among multiple interconnected processing systems or nodes.

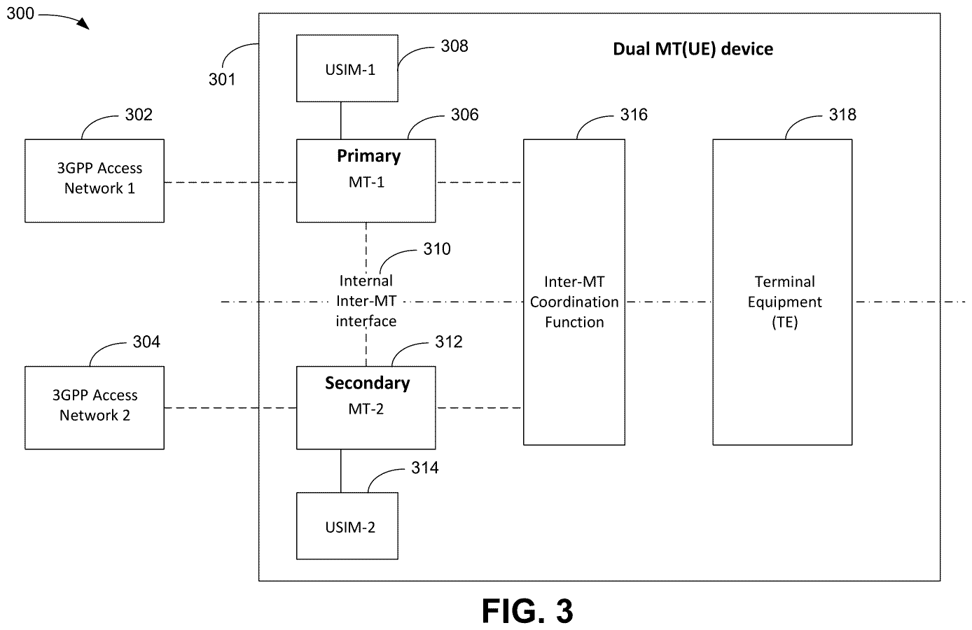

In accordance with some embodiments of this disclosure, the devices and systems of FIGS. 1A-1D and 2 may be used in connection with devices, systems, and methods for network assisted coordination for multi-steer devices (including, but not limited to, DualSteer devices). For example, the devices and systems of FIGS. 1A-1D and 2 may be used in connection with the devices, systems, and methods described in FIGS. 3-8, in some embodiments of this disclosure.

In some embodiments, the MSCF assists in establishing multi-steer PDU sessions for multi-steer devices. Each multi-steer UE of a multi-steer device may be registered on one of the 3GPP access types (e.g., NR, Non-Terrestrial NR, E-UTRA) and one of the network types (e.g., H-PLMN, V-PLMN, PNI-NPN). The MSCF may provide aggregation of two or more devices with transmit/receive capabilities (e.g., sensing devices onboard a vehicle). The MSCF may also be referred to as a DualSteer Coordination Function (DSCF) or a Device Aggregation Control Function (DACF). Devices capable of participating in such device aggregation or multi-steering procedures may be called multi-steering or device aggregation capable devices.

In some embodiments, procedures for the MSCF to assist multi-steer devices are as follows.

The MSCF may create, store, or maintain, or any combination thereof, context information (e.g., UE ID such as SUPI/GPSI, multi-steer specific ID, multi-steer user ID (MSUID), multi-steer Session ID (MSSID), Anchor ID (SMF and/or UPF IDs), a common PDU session ID, any other suitable information, or any combination thereof) for each multi-steer device (and/or for each respective UE or WTRU of a multi-steer device), and may associate, link, or otherwise connect respective multi-steer UEs belonging to a common multi-steer device. The MSCF may assist the multi-steer UEs to coordinate with the other multi-steer UEs. The MSCF may exchange the information related to PDU session with the NFs across the PLMNs to locate a common anchor in an efficient manner. The MSCF may manage when one or more multi-steer UEs join and leave a shared multi-steer PDU session.

The benefits of the present disclosure may include enabling a core network node to provide a multi-steer PDU session for a multi-steer device. The multi-steer PDU session may include associated PDU sessions for the two or more UEs belonging to the same multi-steer device. The multi-steer PDU session may allow steering, switching or splitting of traffic between the UEs, resulting in enhanced efficiency in terms of redundancy, data throughput optimization, and/or load balancing for seamless operation, both for roaming and non-roaming scenarios.

The MSCF may allow use cases of device aggregation involving two or more devices with transmit/receive capabilities (e.g., sensing devices onboard a vehicle). In that regard, the MSCF may be called a Device Aggregation Control Function (DACF). The devices that are capable of participating in such device aggregation or multi-steer procedures may be called device aggregation capable devices.

In accordance with some embodiments of this disclosure, MSCF functionality is provided is follows.

In accordance with some embodiments, based on the assumption that multi-steer functionality is supported by the UEs and the core-network (CN), network (e.g., 5G) system architecture may be enhanced to introduce a new network function called Multi-Steer Coordination Function (MSCF) that may assist the multi-steer devices to establish a multi-steer PDU session with two or more UEs in a computationally efficient manner.

The MSCF may be a logical function in the (CN) or outside the CN in the application layer domain, e.g. application layer enablement domain managed by a network operator. The MSCF may be reachable using Control Plane or User Plane based mechanisms.

The MSCF may handle the network related operations to enable coordination and collaboration between the multi-steer UEs via the NFs (e.g. AMF, SMF, UDM) for multi-steer operations. The MSCF is a new functionality that may be located in a standalone NF in the CN, located in an existing NF such as the PCF, UDM, AMF or SMF, or located in an application server.

If the MSCF is in the core network as a standalone network function, then new interfaces may be used to interact with the other network functions (e.g., an interface with AMF, an interface with SMF, an interface with PCF, an interface with UDM, an interface with the other MSCF in the same PLMN, an interface with the other MSCF in a different PLMN, or any combination thereof).

If the MSCF is in the core network inside or beside other network functions (e.g., PCF), then the existing interfaces could be used to interact with the other network functions, e.g., N15 for AMF to MSCF (PCF), N7 for SMF to MSCF (SMF), N43 for MSCF to MSCF (PCF to PCF) and so forth. In some embodiments, existing signaling messages could be enhanced (policy association request or response, policy control request or response) or the new message could be specified as required.

Features for the MSCF to assist multi-steer devices to enable multi-steer functionality are provided as follows.

A MSCF may create, store, maintain, or any combination thereof the context information in the network, e.g., UE ID such as SUPI/GPSI, multi-steer specific ID, Anchor ID (SMF and/or UPF IDs), a common PDU session ID etc. for each multi-steer UE, and may associate, link, or otherwise connect the multi-steer UEs belonging to a common multi-steer device. The context information may also indicate which UE of the multi-steer device is a primary UE. The MSCF of the primary UE may be denoted as primary MSCF, while the MSCF of the other UEs may be denoted as a secondary MSCF. The primary MSCF may maintain a list of all registered UEs of the multi-steer device. For each registered UE, the context information may also indicate the status of the UE's PDU session (e.g., not established, established and activated, established and deactivated) as well as the identity of the secondary MSCF related to that UE. The context information may contain the information that is used for PDU session release procedure (e.g., the PDU session is released for the Primary UE), in which case the PDU session may be released for some or all UEs.

A MSCF may assist with coordination among all multi-steer UEs via the network functions (e.g., AMF, SMF, PCF).

MSCFs located in different networks (e.g., PLMN1, PLMN2) can discover each other via a network repository function (NRF) MSCF discovery procedure.

A MSCF may exchange the information related to a PDU session with the NFs across the PLMN (same or different PLMNs) to locate a common anchor in an efficient manner.

A MSCF may manage the multi-steer UEs, when the UEs are joining and/or leaving the shared multi-steer PDU session.

In accordance with some embodiments of this disclosure, session and mobility management are provided as follows.

In some embodiments, the Access and Mobility management Function (AMF) receives a registration request from a multi-steer UE. The AMF may retrieve or receive multi-steer specific ID from the Unified Data Management (UDM) or construct the multi-steer specific ID using the user identifier of the UE, PLMN ID, any unique identifier assigned to the multi-steer device as part of a subscription which can be shared or known to all UEs belonging to the multi-steer device, or any combination thereof. During registration, the AMF may interact with the MSCF for the construction of a multi-steer specific ID. Upon successful registration, the AMF may initiate multi-steer context creation at MSCF for the UE by sending a create or update multi-steer context request message to MSCF. The multi-steer context request message could be a new message or an enhancement to an existing message (e.g., poly association message in case MSCF is in the PCF). The message may include SUPI, multi-steer specific ID, GPSI or URSP rules, or any combination therein. The AMF may receive an acknowledgement from the MSCF via the create or update multi-steer context response message. As referred to herein, a multi-steer context (e.g., multi-steer ID) could be a DualSteer context (e.g., DualSteer ID). The multi-steer context or DualSteer context may be generated for each respective UE, for each respective WTRU, or for any combination thereof. It will be understood that any description pertaining to a DualSteer context also pertains to a multi-steer context. It will also be understood that any description pertaining to a multi-steer context also pertains to a DualSteer context. As referred to herein, a multi-steer specific ID could be a DualSteer specific ID. It will be understood that any description pertaining to a DualSteer specific ID also pertains to a multi-steer specific ID. It will also be understood that any description pertaining to a multi-steer specific ID also pertains to a DualSteer specific ID.

In some embodiments, the AMF receives a PDU session establishment request from the UE. If the requested PDU session is a multi-steer PDU session, the AMF may coordinate with the MSCF as part of a SMF selection procedure to retrieve the context and routing information of the UE (e.g., if stored at the MSCF). The AMF may send a multi-steer context request message to the MSCF to retrieve the UE context saved on the MSCF, which may be in order to determine whether there is an anchor for data traffic associated to the UE's multi-steer session. As used herein, the terms anchor, DualSteer session anchor, or multi-steer session anchor, may refer to a user plane anchor and/or control plane anchor related to a multi-steer session. The user plane anchor may be the UPF which provides connectivity to the data network, and which may manage the steering, switching, and/or splitting of the downlink traffic for a multi-steer device. The anchor may be the SMF which provides session management configuration for the steering, switching, and/or splitting of multi-steer device traffic. The control plane anchor may be the SMF which stores the anchor information for a multi-steer session. The AMF may receive a multi-steer context response message from the MSCF including the multi-steer access status set to failure and routing info set to Null, which implies that no PDU session or anchor exists for the associated multi-steer specific ID, which may be the case if there is no context at the MSCF because the UE is the primary UE and the first to establish a PDU session. As referred to herein, the term Primary UE, may be used to refer to the UE of a multi-steer device that may control overall multi-steer device behavior. For example, if the PDU session of the Primary UE is released, the multi-steer PDU session may release all associated PDU sessions.

The AMF may receive a multi-steer context response message from the MSCF including the multi-steer access status set to success and routing info set to SMF and/or UPF ID, which implies that the PDU session or anchor exists for the associated multi-steer specific ID. The AMF may perform the SMF selection based on the information received from the MSCF.

In some embodiments, the MSCF assists with UE coordination among multi-steer UEs via any suitable network functions (e.g., AMF, SMF, PCF, or any combination thereof). MSCFs may be associated with different networks, such as with first and second PLMNs, and may be able to discover each other via a network repository function (NRF), e.g., through a MSCF discover procedure. The MSCF may exchange information related to a PDU session with NFs across the PLMN (e.g., the same or different PLMNs) to locate a common anchor in an efficient manner. The MSCF may manage the multi-steer UEs when the multi-steer UEs join and/or leave a shared multi-steer PDU session. The MSCF may be located standalone in the CN, located in the PCF, AMF or SMF, located in the application server, or any combination thereof.

Traffic steering and switching can occur over two access networks (e.g., two 3GPP access networks). 3GPP has, since the 4G protocol, supported mechanisms that enable traffic steering, switching and splitting between a 3GPP access network (e.g., E-UTRA or NR) and a non-3GPP access network (e.g., WiFi). A recent such mechanism is ATSSS feature supported since R16. However, new mechanisms are provided herein to support traffic steering and switching over two or more 3GPP access networks.

In certain representative embodiments, a multi-steer device may support traffic steering and switching of user data (e.g., for different services) across two or more access networks (e.g., 3GPP access networks). The multi-steer device may include (a) a single UE, in case of non-simultaneous data transmission over the two or more networks, or (b) two or more separate UEs in case of simultaneous data transmission over the two or more networks. The subscriber of the multi-steer device may have two or more subscriptions/SUPIs, sharing one subscription profile from the same operator. For any particular service, at any given time, the multi-steer device may transmit all traffic of that service using only a single access network (e.g., a single 3GPP access network). The multi-steer device may be the WTRU 102 of FIG. 1B that has multi-steer capabilities.

In certain representative embodiments, there various scenarios are provided for cases of two (e.g., 3GPP) access types (e.g., NR, Non-Terrestrial NR, E-UTRA) and various network types (e.g., Home-Public Land Mobile Network (H-PLMN), Visited-Public Land Mobile Network (V-PLMN), Public Network Integrated-Non-Public Network (PNI-NPN)) that the access networks may be connected to.

In certain representative embodiments, multi-steer device may be supported by at least one of the following:

A “multi-steer device” may use two or more SUPIs from the same operator for accessing two or more separate access networks (e.g., 3GPP access networks). Each SUPI may be used to connect to only one of the access networks at any given time.

A “multi-steer device” may send its user data over two or more access networks (e.g., 3GPP access networks) belong to the same PLMN, either non-simultaneously or simultaneously.

A “multi-steer device” may send its user data over two or more access networks (e.g., 3GPP access networks) belong to two or more different PLMNs, either non-simultaneously or simultaneously.

In case of non-simultaneous data transmission over two or more networks, a “multi-steer device” may be a single UE. In case of simultaneous data transmission, a “multi-steer device” may be “two or more separate UEs”.

In case of simultaneous data transmission, the data over two or more separate networks may belong to different services (or different Service Data Flows).

At any given point of time, all traffic of a single service may be sent over a single access network, i.e., no service data splitting.

In accordance with some embodiments of this disclosure, splitting traffic across two access legs (e.g., 3GPP access legs) is provided as follows.

In certain representative embodiments, carrier aggregation may be provided over a single access (e.g., New Radio (NR) or Long Term Evolution (LTE)) but allows the UE to receive over two or more cells. The cells may be each on a different frequency carrier. The use of the two cells may be managed entirely in the Radio Access Networks (RANs).

In certain representative embodiments, UEs also support Dual Connectivity (DC). DC allows a UE to receive/transmit over two 3GPP accesses (or 3GPP access legs). The accesses may be NR (gNB) or LTE (eNB). In certain representative embodiments, in 5G, the deployments may have one leg over LTE and a second leg over NR. In certain representative embodiments, deployments of DC may also support two legs over NR. In this case, the two legs may be on different bands (e.g., FR1 and FR2). In order to employ DC, a UE may need the Radio Frequency (RF) front end to support both accesses. In dual connectivity, one leg may be the master leg (and part of a Master Cell Group (MCG)), and the other leg may be the secondary leg (and part of a Secondary Cell Group (SCG))

In certain representative embodiments, for the Public Land Mobile Network PLMN plus PLMN/Non-Public Network (NPN) examples, the two networks may be managed by the same operator or by different operators (e.g., assumed to have a business agreement among them).

In accordance with some embodiments of this disclosure, various UE identities are provided as follows.

In certain representative embodiments, the Subscription Permanent Identifier (SUPI) may be a 5G globally unique identifier allocated to each subscriber. The SUPI value may be provisioned in Universal Subscriber Identity Module (USIM) and UDM/UDR function in 5G Core. The SUPI may be either an International Mobile Subscriber Identifier (IMSI) or a Network Access Identifier (NAI). For the IMSI version of the SUPI, the first three digits represent the Mobile Country Code (MCC), the next two or three represent the Mobile Network Code (MNC) identifying the network operator or PLMN. The remainder may represent the Mobile Subscriber identification number (MSIN).

In certain representative embodiments, Subscription Concealed Identifier (SUCI) is a privacy preserving identifier containing the concealed SUPI. The SUCI may include the PLMN ID of the home network (in MCC and MNC). The MCC/MNC may be transmitted in plain text.

In certain representative embodiments, the 5G GUTI (Globally Unique Temporary Identifier) may be allocated by the AMF (Access and Mobility Management Function). The AMF may assign a new 5G-GUTI to the UE at any time. The 5G-GUTI may include a GUAMI (Globally Unique AMF ID) and a 5G-TMSI (Temporary Mobile Subscriber Identity), where GUAMI identifies the assigned AMF and 5G-TMSI identifies the UE uniquely within the AMF. The GUAMI may be a concatenation of the PLMN ID and the AMF identifier.

In accordance with some embodiments of this disclosure, multi universal subscribed identity module (MUSIM) operation is provided as follows.

In certain representative embodiments, a UE may have multiple USIMs that may be in operation at the same time, where each USIM allows the UE to obtain service from a different mobile network. One use case for MUSIM devices may be for professionals who need a business number and a separate personal number. Instead of carrying two phones, these professionals may use a single phone with two USIM cards.

In certain representative embodiments, the terminal behavior with respect to the simultaneous handling of multiple USIMs may depend on the UE capabilities (e.g., UE with single Rx/single Tx vs UE with dual Rx/single Tx vs UE with dual Rx/dual Tx), wherein dual Rx may allow a MUSIM UE to simultaneously receive traffic from two networks, single RX allows MUSIM UE to receive traffic from one network at one time, and single Tx allows MUSIM UE to transmit traffic to one network at one time.

In some embodiments, the two USIMs may run independently of each other. Each USIM may specify that the UE have a dedicated Non-Access Stratum and Access Stratum protocol stacks. However, depending on the capabilities of the UE, some coordination may be needed to allow the UE to obtain service to both mobile networks. In some embodiments, this coordination may not rely on mobile network interactions. As a result, the UE may act as a mediator between the two mobile networks.

In certain representative embodiments, an AMF may use the N14 interface for AMF re-allocation and AMF to AMF information transfer. This interface may be either intra-PLMN or inter-PLMN (e.g., in the case of inter-PLMN mobility). At inter PLMN mobility, the source AMF may select an AMF instance(s) in the target PLMN by querying target PLMN level NRF via the source PLMN level NRF with target PLMN ID. The target PLMN level NRF may return an AMF instance address based on the target operator configuration. After the Handover procedure the AMF may select a different AMF.

FIG. 3 shows an illustrative communication system 300 including a WTRU with two respective UEs, according to some embodiments of this disclosure. The Dual-MT device 301 may be any suitable WTRU 102 of FIG. 1B that has DualSteer capabilities. The Dual-MT device 301 may simultaneously connect to two (e.g., 3GPP) access legs. In some representative embodiments, a WTRU may have two separate mobile terminations (MTs) (e.g., Primary MT-1 306 and Secondary MT-2 312) and USIMs (e.g., USIM-1 308 and USIM-2 314). For example, each MT may provide one or more functionalities of a MT (e.g., at least one of radio transmission, radio reception, baseband signal processing, access to USIM, access to CP stack, access to UP stack, combinations of the same, or the like) that is in a traditional UE. One MT may be considered a primary MT, while the other MT may be considered a secondary MT. A common Terminal Equipment (TE) may be provided (as shown, for example, in FIG. 3). In certain representative embodiments, two separate TEs corresponding to two MTs may be provided. An internal inter-MT interface between two MTs may be provided. The internal inter-MT interface may be configured to allow two MTs to exchange information. In certain representative embodiments, two MTs may exchange information through a higher layer “Inter-MT Coordination Function (IMCF)”. Two MTs may be identified by two unique device identifiers such as IEIs. An additional ID called DualSteer specific UE ID (DS-specific-UE-ID) may be used to interlink the Primary and Secondary MT in a DualSteer or Dual-MT device. In some embodiments, two or more UEs belonging to a DualSteer device but not located in the same physical device would be an extension to the Dual-MT device model.

In certain representative embodiments, as illustrated in the example of FIG. 3, a system 300 is provided. The system 300 may include a Dual-MT device 301 configured to communicate with a first 3GPP access network 302 and/or a second 3GPP access network 304. The Dual-MT device 301 may include a first or primary MT 306 and a second or secondary MT 312. The first or primary MT 306 and the second or secondary MT 312 may communicate, e.g., via an internal inter-MT interface 310. The first or primary MT 306 may have a first USIM 308. The second or secondary MT 312 may have a second USIM 314.

For example, an Inter-MT Coordination Function (IMCF) 316 may be provided. The IMCF 316 may be provided in the higher layer. The IMCF 316 may be part of a TE 318. The communication between MTs or between the MT and the IMCF 316 may use AT commands. Two MTs may be identified by two unique device identifiers such as International Mobile Equipment Identities (IMEIs).

Both MTs of FIG. 3 (which may correspond to two respective UEs) may have a separate subscription for registering to mobile network. Primary MT 306 may register to a PLMN at first, and the Secondary MT 312 may register only when it is triggered by the Primary MT directly or via the IMCF layer 316. In accordance with some embodiments of this disclosure, an MT in a DualSteer capable WTRU may include the information of the primary or secondary MT (or UE) as part of its registration request message and send it to the network.

In some embodiments, a DualSteer device may have two UEs or MTs located apart from each other, i.e., not collocated within a device in contrast to the Dual-MT device model of FIG. 3.

For a DualSteer device, the primary UE may establish a PDU session using the existing session establishment procedures, where it establishes a session with the DualSteer capable SMF/UPF. For the secondary UE in the DualSteer device, a common anchor may be required for the DualSteer PDU session (i.e. the same SMF and UPF as primary UE, via the secondary UE's AMF) and proceeds to locate and select the SMF for the secondary UE for DualSteer session establishment may require a significant amount of overhead signaling, without using the MSCF of the present disclosure.

Typical solutions for managing DualSteer devices may assume that a DualSteer device has two UEs where both are subscribed to the same PLMN. In such cases, a DualSteer PDU session has two associated PDU sessions, one for each of the two UEs. To establish a DualSteer PDU session for a DualSteer device, the two associated PDU sessions need to share a common anchor SMF and anchor UPF. However, such solutions are inefficient because of the overhead control plane signaling needed to locate these anchors, e.g., serving SMF that serves both UEs for the DualSteer PDU sessions. Additionally, support for more than two UEs associated to a DualSteer device and/or for these UE's subscribed to different PLMNs is currently not defined.

The overhead control plane signaling is expected to increase further for cases in which more than two UEs belong to the same DualSteer device (e.g., where the DualSteer device may be either a single physical device or separate devices). These two or more UEs capable of DualSteer functionality should be able to steer, switch, or split the traffic for load balancing, for redundancy, or to increase throughput. The existing solutions for the DualSteer session establishment cannot support and/or be scaled for more than two UEs because of inherent inefficiency.

The overhead control plane signaling is expected to increase further for cases where the UEs of the DualSteer device have subscriptions with different PLMNs (different mobile network operators). One or more network functions to collaborate between multiple UEs for DualSteer operations, in both inter-PLMN and intra-PLMN scenarios, are not defined.

To address one or more of the above stated issues, it is desirable for networks (e.g., 5G systems) to be enhanced for the support of multi-steer functionality using two or more UEs in the following ways. In some embodiments, enhancements include making the PDU session establishment/modification/release procedure efficient for multi-steer capable devices with two or more UEs. In some embodiments, enhancements include enabling coordination and collaboration between the multi-steer capable UEs for both inter-PLMN and intra-PLMN scenarios. In certain representative embodiments, the MSCF of the present disclosure provides one or more of these enhancements.

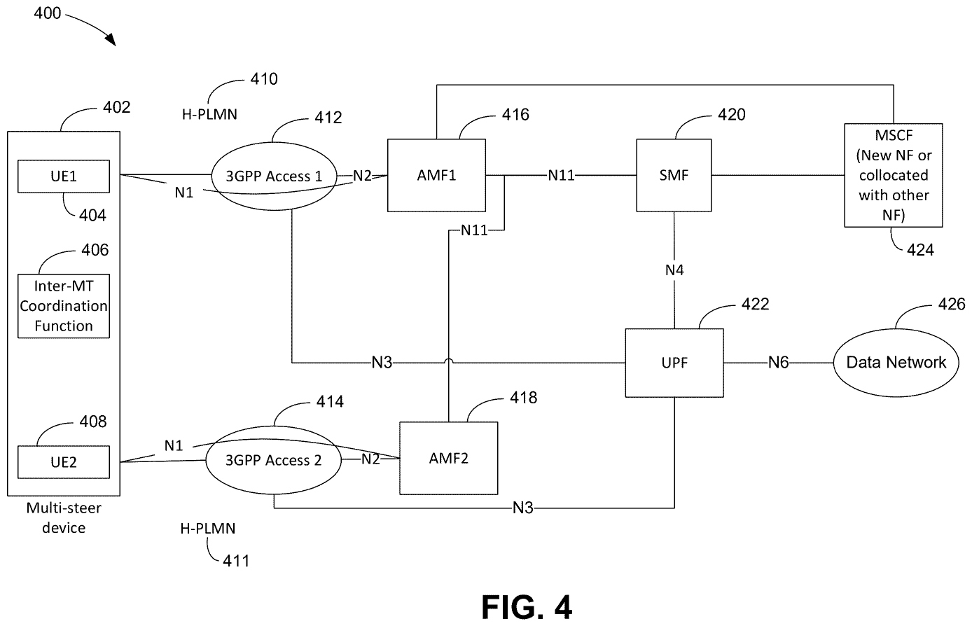

FIG. 4 shows an illustrative non-roaming multi-steer architecture, according to some embodiments of this disclosure. This architecture may allow a multi-steer device (e.g., multi-steer device 402, or any suitable WTRU 102 with multi-steer capability) to connect to two or more separate access networks (e.g., 3GPP Access 1 412, 3GPP Access 2 414) simultaneously. The multi-steer device may establish PDU sessions, each associated with a different access network. Two separate Access and Mobility Management Functions (AMFs) (e.g., AMF1 416 and AMF2 418) may manage the mobility and session context for the multi-steer device on their respective networks. A single Session Management Function (SMF) may control the overall PDU sessions and traffic steering for the multi-steer device across both access networks. User plane data may be anchored at a User Plane Function (UPF) 422, which may route traffic between the data network 426 and the multi-steer device through one or both access networks as directed by the SMF 420 and/or the MSCF 424. The MSCF 424 may be communicatively connected to an AMF (e.g., AMF1 416) and/or the SMF 420. The MSCF may be a distinct NF or be collocated with another NF.

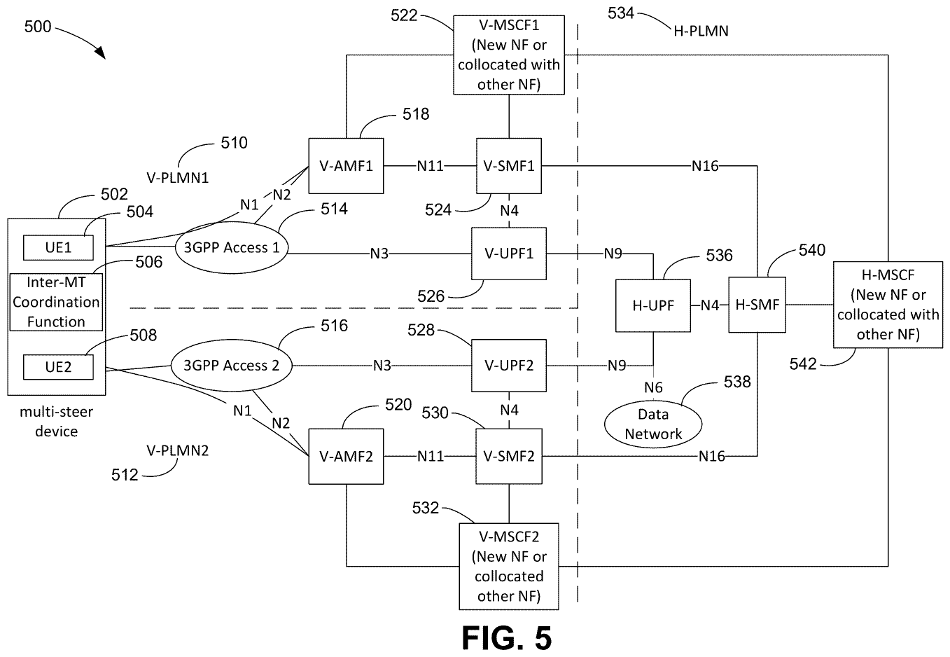

FIG. 5 shows an illustrative roaming DualSteer architecture with two different V-PLMNs (e.g., V-PLMN1 510 and V-PLMN2 512) and a common H-PLMN 534, according to some embodiments of this disclosure. The DS device 502 may establish connections with two distinct access networks (3GPP Access 1 514 in V-PLMN1 518 and 3GPP Access 2 516 in V-PLMN2 512).

Each V-PLMN may have its own respective Access and Mobility Management Function (AMF) (e.g., V-AMF1 518 and V-AMF2 520) and Session Management Function (V-SMF) (e.g., V-SMF1 524 and V-SMF2 530), responsible for managing UE's mobility and session context in their respective networks. Traffic may flow between the multi-steer device 502 (e.g., any suitable WTRU 102 with multi-steer capability) and the Data Network 538 through a V-UPF (e.g., V-UPF1 526, V-UPF2 528) or H-UPF 536 as directed by the SMFs and/or MSCF (e.g., V-MSCF1 522, V-MSCF2 532, H-MSCF 542, or any combination thereof). Each MSCF may be communicatively connected to a respective AMF (e.g., V-AMF1 518, V-AMF2 520) and/or a respective SMF (e.g., V-SMF1 524, V-SMF2 530, H-SMF 540). Each MSCF may be a distinct NF or may be collocated with another NF.

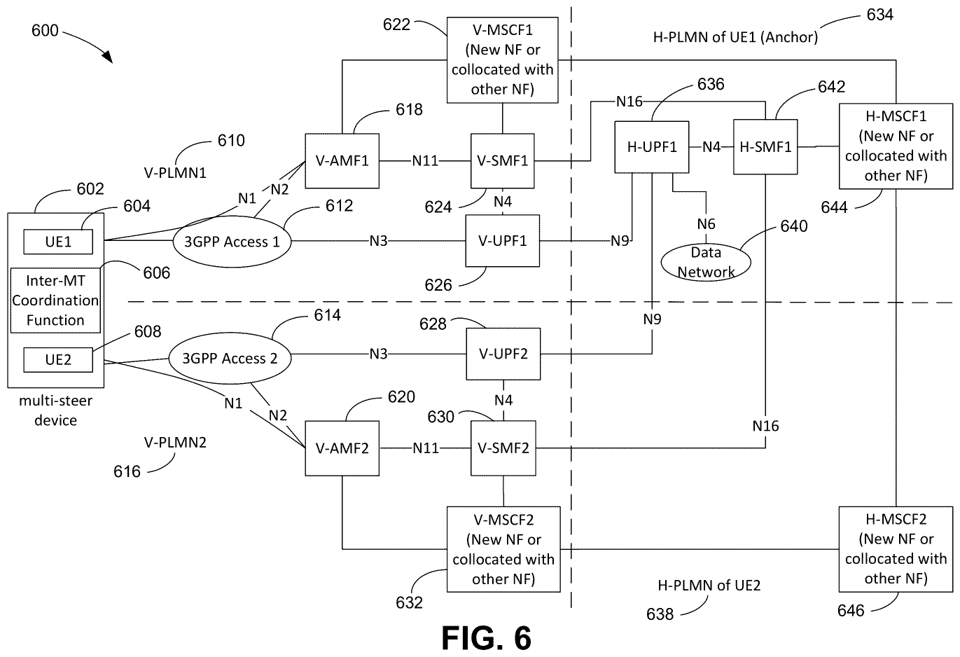

FIG. 6 shows an illustrative roaming multi-steer architecture with two different V-PLMNs and two different H-PLMNs, according to some embodiments of this disclosure. The DS device 602 may establish connections with two distinct access networks (3GPP Access 1 612 in V-PLMN1 610 and 3GPP Access 2 614 in V-PLMN2 616). UE1 602 may be associated with H-PLMN 634, which may be an anchor. UE2 608 may be associated with H-PLMN 638, which may be a secondary H-PLMN.

Each V-PLMN may have its own respective Access and Mobility Management Function (AMF) (e.g., V-AMF1 618 and V-AMF2 620) and Session Management Function (V-SMF) (e.g., V-SMF1 624 and V-SMF2 630), responsible for managing UE's mobility and session context in their respective networks. Traffic may flow between the DS device 602 (e.g., any suitable WTRU 102 with multi-steer capability) and the Data Network 640 through a V-UPF (e.g., V-UPF1 626, V-UPF2 628) or H-UPF1 636 as directed by the SMFs (e.g., V-SMF1 624, V-SMF2 630, H-SMF1 642) and/or MSCF (e.g., V-MSCF1 622, V-MSCF2 632, H-MSCF1 644, H-MSCF2 646, or any combination thereof). Each MSCF may be communicatively connected to a respective AMF (e.g., V-AMF1 618, V-AMF2 620) and/or a respective SMF (e.g., V-SMF1 624, V-SMF2 630, H-SMF1 642). Each MSCF may be a distinct NF or be collocated with another NF. The H-PLMN of UE1 634 may be an anchor, which may provide connectivity to the data network 640 and may manage steering, switching, and/or splitting of downlink traffic for the DS device 602.

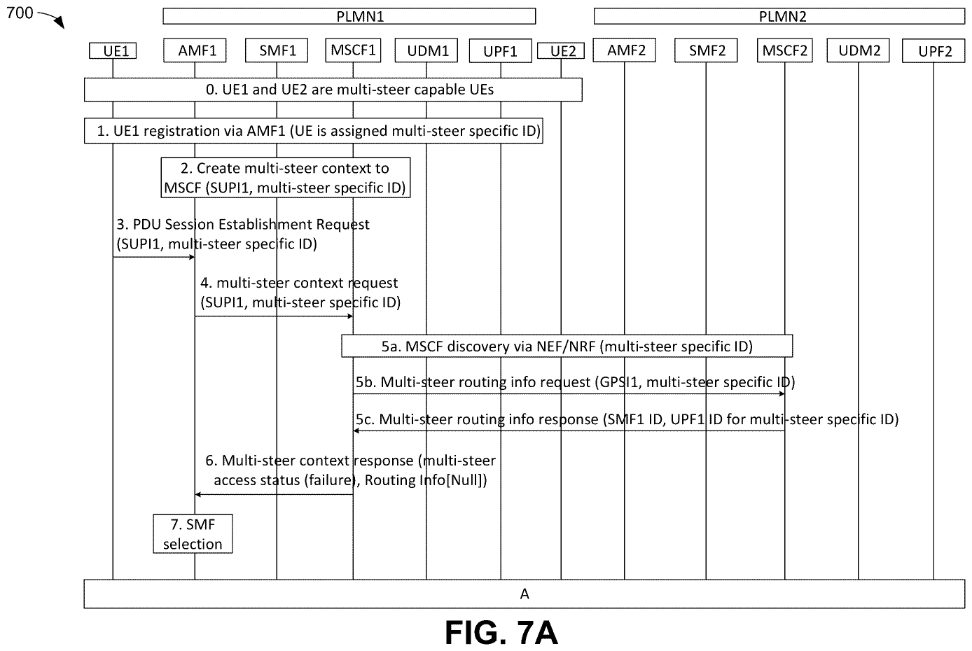

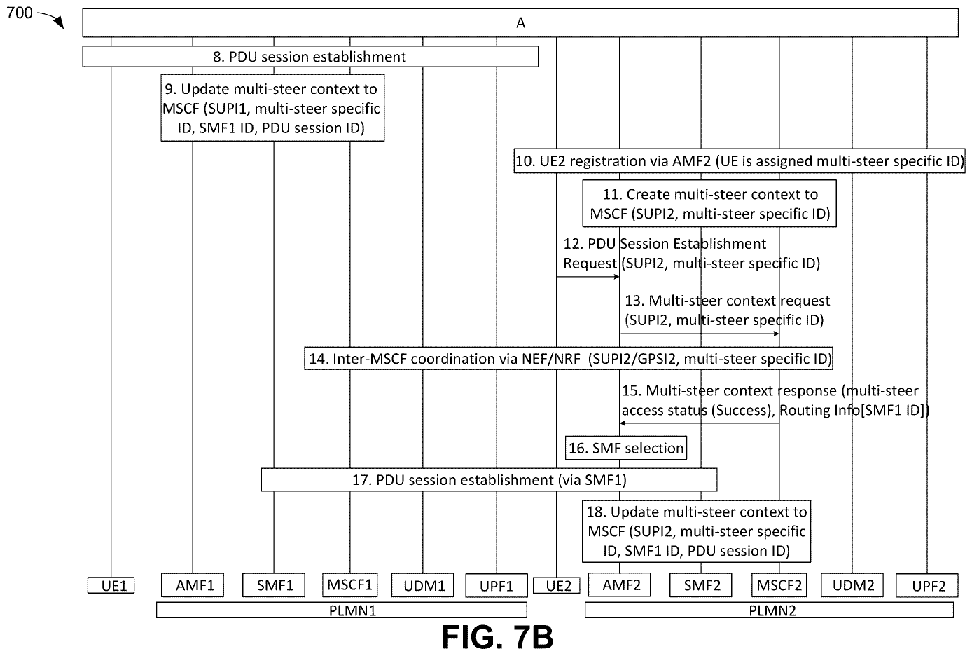

FIG. 7A is a first portion of an illustrative flow diagram 700 of steps for establishing a multi-steer PDU session with assistance from a MSCF, according to some embodiments of this disclosure. Certain steps of the method shown in FIG. 7A are described in more detail as follows below. In some embodiments, the MSCF is reachable by UEs via a User Plane. The MSCF may be in the core network, in the application enablement layer, or outside the 3GPP network. In some embodiments, the flow diagram of FIGS. 7A-7B may be performed using the multi-steer architectures of FIGS. 4, 5, and/or 6.

As shown at step 0 of FIG. 7A, a system may include two multi-steer capable UEs, UE1 and UE2. In some embodiments, one of the UEs may act as a primary UE while the other UE may act as a secondary UE. Each UE may have its own USIM. The UEs may be any of the UEs of WTRUs 102, dual-MT device 301, or multi-steer devices 402, 502, 602. UE1 may be connected to a first PLMN (e.g., PLMN1) including an AMF (e.g., AMF1), a SMF (e.g., SMF1), a MSCF (e.g., MSCF1), a UDM (e.g., UDM1), and a UPF (e.g., UPF1). UE2 may be connected to a second PLMN (e.g., PLMN2) including an AMF (e.g., AMF2) a SMF (e.g., SMF2), a MSCF (e.g., MSCF2), a UDM (e.g., UDM2), and a UPF (e.g., UPF2).

At step 1 of FIG. 7A, UE1 may register to a CN (e.g., a 5G CN) via AMF1 using a UE identifier (e.g., SUPI1, GUTI1, 5G-GUTI1) and may receive a multi-steer specific UE ID. AMF1 and/or PCF1 may retrieve subscription information from UDM1 for UE1 and may receive multi-steer specific ID from UDM1 or construct the ID using the user identifier of UE1, PLMN1 ID, any unique identifier assigned to the multi-steer device as part of subscription, or any combination thereof, which can be shared with all the UEs belonging to the multi-steer device. AMF1 may interact with MSCF1 for the construction of a multi-steer specific ID. UE1 may include an indication that AMF1 should create a context for UE1 in the MSCF1. In some embodiments, this indication may be an explicit indication carried in the registration message. In some embodiments, this indication may be an implicit indication, for example, based on other information carried in the registration message, such as an indication that UE1 is part of a multi-steer device.

At step 2 of FIG. 7A, after UE1 has successfully completed the initial registration and/or a registration update procedure, the AMF1 may initiate multi-steer context creation at MSCF1 for UE1 by sending a create or update multi-steer context request message to MSCF1, which could be a new message or enhancement to an existing message (e.g., policy association messages in case MSCF1 is in the PCF). The message may include SUPI1, DualSteer Specific ID, GPSI or URSP rules, or any combination thereof. The MSCF1 may create a multi-steer context (e.g., multi-steer ID) for a single UE, for a single WTRU, for a single DualSteer or multi-steer device, for multiple instances of any of those devices, or for any combination thereof. The MSCF1 may save the information of UE1 received from the AMF1. The MSCF1 may send an acknowledgement by sending create or update multi-steer context response messages to AMF1.

At step 3 of FIG. 7A, UE1 may send a PDU session establishment request to AMF1. The request may include a UE ID (e.g., a SUPI) and/or a multi-steer specific ID.

At step 4 of FIG. 7A, AMF1, after reception of PDU session establishment request from UE1, may initiate a SMF selection procedure. If the requested PDU session is a multi-steer PDU session, AMF1 may coordinate with the MSCF1 to retrieve the context and routing information. Messages between the AMF1 and MSCF1 may be new messages (e.g., a multi-steer context request indicating a UE ID and/or a multi-steer specific ID) or enhancements to existing messages (e.g., policy association messages in case MSCF1 functionality are part of the PCF).

In some embodiments, AMF1 may use the context and routing information to determine an SMF (e.g., SMF1). The context and routing information may include a UPF ID. AMF1 may send the UPF ID to the SMF. In some embodiments, the SMF (e.g., SMF1) may send a request to the MSCF (e.g., MSCF1) for context and routing information. The SMF may provide the multi-steer specific ID to the MSCF so that the MSCF can determine what context and routing information is needed by the SMF. The SMF may receive a UPF ID. The SMF may use the UPF ID in a UPF selection procedure.

AMF1 may send a multi-steer context request message to MSCF1 to retrieve the UE1 context saved on the MSCF1, which may be to learn whether there is an anchor for data traffic associated previously to the multi-steer session of UE1. The message may include SUPI1, multi-steer specific ID, GPSI or URSP rules, or any combination thereof. Upon reception of multi-steer context request message, the MSCF1 may search for the routing info locally or may proceed to step 5.

For the procedure exemplified here, step 5 may not have any significance in the case that UE1 is the first UE to register and AMF1 could select any multi-steer capable SMF (e.g., SMF1). In such a case, step 5 could be skipped.

Steps 5a, 5b, and 5c of FIG. 7A may establish the inter-MSCF coordination to retrieve the traffic routing information associated to multi-steer specific ID. In some embodiments, these steps may be implemented in scenarios when UE1 is not the primary UE. In some embodiments, these steps may be implemented in scenarios in which the PDU session procedure is to steer the traffic back from the secondary UE (UE2) to the primary UE (UE1). In some embodiments, these steps may be implemented in scenarios in which the PDU session is to modify an existing multi-steer PDU session in which the role of primary and secondary UE is exchanged.

At step 5a of FIG. 7A, MSCF1 may perform the MSCF discovery procedure via the NEF or NRF and may include the multi-steer specific ID, which may be known to other MSCFs (e.g., if the session was previously established). In some embodiments, the other MSCFs may not be discovered, and the discovery may be unsuccessful. In such cases, steps 5b and 5c may be skipped, and step 6 may be performed.

At steps 5b and 5c of FIG. 7A, if the discovery of step 5a is successful, then MSCF1 may send a multi-steer routing info request, which may include the GPSI, multi-steer specific ID, or another common identifier saved on MSCF1, or any combination thereof. The multi-steer routing info request may also include an identifier for MSCF1. In response to the request in step 5b, at step 5c, MSCF1 may receive a multi-steer routing info response, which may include the SMF1 ID and/or UPF1 ID associated to the multi-steer specific ID and PDU session.

At step 6 of FIG. 7A, if step 5 was skipped because, for example, UE1 is the primary UE and first to establish a PDU session, or, as another example, the step 5a discovery was unsuccessful because, for example, no MSCF is available that has context associated to the multi-steer ID, then MSCF1 may send a multi-steer context response message to the AMF1, which may include the multi-steer access status set to failure, and Routing info set to Null, which may imply that no PDU session or anchor exists for the associated multi-steer specific ID.

At step 7 of FIG. 7A, AMF1 may perform the SMF selection based on the information received in step 6. If no routing information is available in step 6, then the AMF1 may choose any multi-steer capable SMF (e.g., SMF1).

FIG. 7B is a second portion of the illustrative flow diagram 700 of steps for establishing a multi-steer PDU session with assistance from a MSCF, according to some embodiments of this disclosure.

At step 8 of FIG. 7B, the PDU session may be established. In some embodiments, the PDU session is established using the procedure 4.3.2.2.1 in 3GPP technical specification (TS) 23.502. During the PDU session establishment procedure, AMF1 may send the UPF ID that was received from MSCF1 to SMF1. SMF1 may then use the UPF ID in a UPF Selection procedure.

At step 9 of FIG. 7B, after the PDU session is established, the SMF1 may update the context in MSCF1 to include the SMF1 ID and UPF1 ID. The SMF1 may use a new message between SMF1 and MSCF1 or may use existing messages (e.g., SM policy association message if MSCF1 is in the PCF).

At step 10 of FIG. 7B, UE2 may register to a CN (e.g., a 5G CN) via AMF2 using a UE identifier (e.g., SUPI2, GUTI2, 5G-GUTI2) and may receive a multi-steer specific UE ID. AMF2 and/or PCF2 may retrieve subscription information from UDM2 for UE2 and may receive multi-steer specific ID from UDM2 or construct the ID using the user identifier of UE2, PLMN2 ID, any unique identifier assigned to the multi-steer device as part of subscription, or any combination thereof, which can be shared with all the UEs belonging to the multi-steer device. AMF2 may interact with MSCF2 for the construction of a multi-steer specific ID. UE2 may include an indication that AMF2 should create a context for UE2 in the MSCF2. In some embodiments, this indication may be an explicit indication carried in the registration message. In some embodiments, this indication may be an implicit indication, for example, based on other information carried in the registration message, such as an indication that UE2 is part of a multi-steer device.

At step 11 of FIG. 7B, after UE2 has successfully completed the initial registration and/or a registration update procedure, the AMF2 may initiate multi-steer context creation at MSCF2 for UE2 by sending a create or update multi-steer context request message to MSCF2, which could be a new message or enhancement to an existing message (e.g., policy association messages in case MSCF2 is in the PCF). The message may include SUPI2, multi-steer specific ID, GPSI or URSP rules, or any combination thereof. Similar to the MSCF1, the MSCF2 may create a multi-steer context (e.g., multi-steer ID) for a second device (e.g., where the second device is physically or logically coupled to the first device in a DualSteer or multi-steer context). The MSCF2 may save the information of UE2 received from the AMF2. The MSCF2 may send an acknowledgement by sending create or update multi-steer context response messages to AMF2.

At step 12 of FIG. 7B, UE2 may send a PDU session establishment request to AMF2. The request may include a UE ID (e.g., a SUPI) and/or a multi-steer specific ID.

At step 13 of FIG. 7B, AMF2, after reception of PDU session establishment request from UE2, may initiate a SMF selection procedure. If the requested PDU session is a multi-steer PDU session, AMF2 may coordinate with the MSCF2 to retrieve the context and routing information. Messages between the AMF2 and MSCF2 may be new messages (e.g., a multi-steer context request indicating a UE ID and/or a multi-steer specific ID) or enhancements to existing messages (e.g., policy association messages in case MSCF2 functionality are part of the PCF).

AMF2 may send a multi-steer context request message to MSCF2 to retrieve the UE2 context saved on the MSCF2, which may be to learn whether there is an anchor for data traffic associated previously to the multi-steer session UE2. The message may include SUPI2, multi-steer specific ID, GPSI or URSP rules, or any combination thereof. Upon reception of multi-steer context request message, the MSCF2 may search for the routing info locally or may proceed to step 14.

At step 14 of FIG. 7B, the MSCF2 may discover MSCF1 via the NEF/NRF. After successful discovery, MSCF2 may coordinate with MSCF1 to get the routing information associated with the multi-steer specific ID, which may include the SMF1 ID and/or UPF1 ID.

At step 15 of FIG. 7B, the AMF2 may receive a multi-steer response from MSCF2 indicating a successful discovery (e.g., a multi-steer access status of “success”) and/or routing information, which may include SMF1 ID and/or UPF1 ID.

At step 16 of FIG. 7B, AMF2 may perform the SMF selection based on the information received in step 15. In some embodiments, because a PDU session was previously established for UE1 with SMF1, AMF2 may select the same SMF for establishing the PDU session for UE2.

At step 17 of FIG. 7B, the multi-steer PDU session may be established (e.g., using the procedure 4.3.2.2.1 in 3GPP TS 23.502). In some embodiments, during the PDU session establishment procedure, AMF2 may send the UPF ID that was received from MSCF2 to SMF2. SMF2 may then use the UPF ID in a UPF selection procedure.

At step 18 of FIG. 7B, after the multi-steer PDU session is established, the SMF2 may update the context in MSCF2 to include the SMF2 ID and UPF2 ID. The SMF2 may use a new message between SMF2 and MSCF2 or may use existing messages (e.g., SM policy association message if MSCF2 is in the PCF).

In some embodiments, the foregoing procedure could be used for the PDU session modification and release procedure, where the MSCF may assist the SMF1 to identify the PDU sessions associated to multi-steer specific ID for modification or release procedures.

In some embodiments, step 2 of FIG. 7A and step 11 of FIG. 7B may occur after (e.g., in response to) the PDU session establishment request, rather than a registration request.

In some embodiments, UE1 may receive the identity of MSCF1 during its registration request or PDU session establishment request. The multi-steer WTRU may provide this identity to UE2. When UE2 registers with PLMN2 or establishes its associated PDU session, UE2 may include the ID of MSCF1 in the request. The ID may be used by MSCF2 to communicate with MSCF1.

In accordance with certain representative embodiments, steps for an alternative method for User Plane based procedures for PDU session establishment for two or more multi-steer UEs are provided as follows. For example, the alternative method may correspond to the method as shown in FIGS. 7A-7B, with any one or more of the following modifications.

In the alternative method, the MSCF may be reachable by UEs via a User Plane. The MSCF may be in the core-network, in the application enablement layer, or outside the 3GPP network.

In some embodiments, at step 0 of the alternative method, a first UE perform step 0-2 of flow diagram 700 and may set up a user plane connection with MSCF1.

In some embodiments, at step 1 of the alternative method, a first UE interested in initiating a multi-steer PDU session may request a multi-steer user ID (MSUID) from the MSCF (e.g., by sending a multi-steer user ID request message and including an application layer ID or another temporary ID and multi-steer capability). The request may include an identifier of the UE and a second identifier. The second identifier can be the application layer ID or another temporary ID. The second identifier may be associated with the application layer session.

In some embodiments, at step 2 of the alternative method, the MSCF provides the multi-steer user ID to the UE in response to a request from the UE (e.g., by sending a multi-steer user ID response message). The MSCF may determine the MSUID by performing a hash function on the second identifier and the UE identifier.

At step 3 of the alternative method, The MSCF may store the MSUID locally and/or in the network. For example, the assigned MSUID may be stored in the UDM/UDR when provided by the MSCF along with a UE ID (e.g., external ID, GPSI, SUPI). The AMF/SMF may subscribe to MSCF or UDM for MSUID updates and be notified by UDM or MSCF when a MSUID updates. The MSCF may interact with an Application Function (AF) for it to store a mapping of an application layer ID associated with the UE received from UE1, together with the allocated MSUID.

In some embodiments, at step 4 of the alternative method, a second UE interested in joining a multi-steer PDU session with another UE provides an application layer ID of the first UE. The application layer ID may be shared for the UEs belonging to the same multi-steer WTRU. The application layer ID may be shared via pre-configuration in the UEs and/or provided to the UEs from the upper layer. The MSCF of the second UE may receive the corresponding MSUID of the first UE from its MSCF. The second MSCF may interact with AF, which may be located based on an application layer ID, to obtain a MSUID and locate the MSCF of the first UE. The MSCF of the second UE may query the MSCF of the first UE to check whether MSUID usage is authorized (e.g., MSUID is active, PDU session is using it). The MSCF of the second UE may store the MSUID in the UDM of the second UE.

In some embodiments, at step 5 of the alternative method, the MSUID is provided by the UEs during session establishment and is used as described in the embodiments above for the AMF to select a common multi-steer capable SMF.

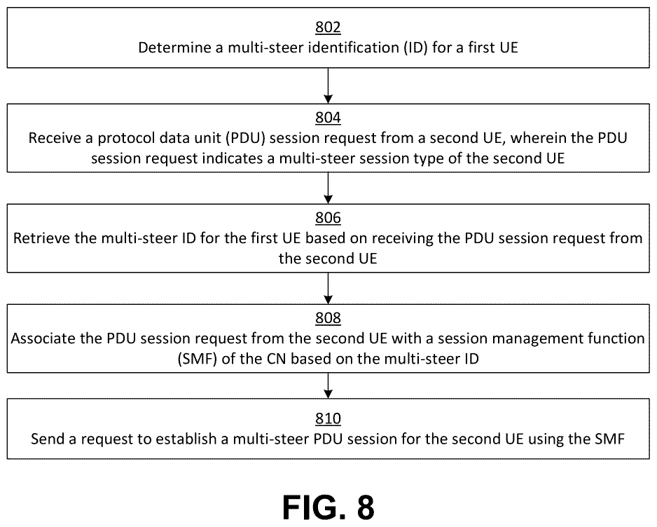

FIG. 8 is an illustrative flow diagram of steps for network assisted coordination for multi-steer devices, according to some embodiments of this disclosure.

In certain representative embodiments, processes of FIG. 8 may be performed by any function (e.g., AMF, MSCF, SMF, UPF), any combination of functions, any node, any combination of nodes, or any combination thereof of the core network. A function may be implemented on one or more than one core network node (e.g., core network node 190) that may include at least one processor (e.g., processor 191) and communication circuitry (e.g., communication circuitry 192). The functionalities of a network function may be executed on the at least one processor of the core network node.

At step 802, at least one processor of a core network node may determine a multi-steer ID for a first UE (e.g., any of WTRUs 102, dual-MT device 301, or multi-steer devices 402, 502, 602, MT-1 306, UE1 404, UE1 504, or UE1 604). In some embodiment, step 802 corresponds to step 2 of FIG. 7A. In some embodiments, step 802 is performed by a SMF initiating multi-steer context creation at an MSCF (e.g., MSCF 424, V-MSCF1 522, V-MSCF2 532, H-MSCF 542, V-MSCF1 622, V-MSCF2 632, H-MSCF1 644, or H-MSCF2 646) for a UE by sending a create or update multi-steer context request message to the MSCF.

In some embodiments, step 802 is performed after the core network receives a registration request from the second UE, wherein the registration request further indicates the multi-steer session type of the second UE.

In some embodiments, the multi-steer ID is determined at 802 based on at least one of a subscription identifier of the first UE or of a second UE, at least one rule for communicating with the first UE or second UE, a CN function ID, a PDU session ID, or an indication of which UE, among at least the first UE and the second UE, is a primary UE.

In some embodiments, the multi-steer ID is determined at 802 by attempting to retrieve the multi-steer ID from a function of the CN (e.g., the MSCF). In some embodiments, in response to a failed attempt to retrieve the multi-steer ID, the multi-steer ID for the first UE is determined based on retrieving an ID associated with the first UE.

At step 804, the at least one processor of the core network node may receive a PDU session request from the second UE, wherein the PDU session request indicates a multi-steer session type for the second UE. For example, an AMF may receive a PDU session establishment request from the second UE. In some embodiments, step 804 corresponds to step 12 of FIG. 7B.

At step 806, the at least one processor of the core network node may retrieve a multi-steer ID for the first UE based on receiving the PDU session request from the second UE. For example, the AMF may coordinate with the MSCF to retrieve context and routing information. In some embodiments, to retrieve the multi-steer ID includes communicating with at least one other node of the CN. In some embodiments, step 806 corresponds to steps 13-15 of FIG. 7B.

At step 808, the at least one processor of the core network node may associate the PDU session request from the second UE with a SMF (e.g., SMF 420, V-SMF1 524, V-SMF2 530, H-SMF 540, V-SMF1 624, V-SMF2 630, or H-SMF1 642) of the CN based on the multi-steer ID.

For example, an AMF may select the SMF based on routing information passed to the AMF by the MSCF. In some embodiments, the PDU session request is associated with the SMF based on determining whether a previously-established PDU session exists for a first UE, wherein the previously-established PDU session was established based on the multi-steer ID. If the previously-established PDU session exists, then the PDU session request is associated with the same SMF of the previously-established PDU session for the first UE. If the previously-established PDU session does not exist, then associating the PDU session request with the SMF may include selecting the SMF from among a plurality of available SMFs based on the multi-steer ID. In some embodiments, step 808 corresponds to step 16 of FIG. 7B.

At step 810, the at least one processor of the core network node may send a request to establish a multi-steer PDU session for the second UE using the SMF. In some embodiments, step 810 corresponds to steps 8 and 17 of FIGS. 7A-7B.

In some embodiments, after the PDU sessions are established, the core network may determine how to route information that is communicated between the first UE, the second UE, and the SMF, wherein the information includes first information from the first UE and second information from the second UE.

In accordance with some embodiments of this disclosure, multi-steer session management are provided as follows.

In some embodiments, the MSUID may identify a UE, or a multi-steer session initiated by the first UE. The UEs may be initiating or participating in multiple multi-steer sessions simultaneously. In the case of MSUID identifying a session, one or more MSUIDs may be associated with the UE.

In some embodiments, if the MSUID uniquely identifies a multi-steer capable UE, then a multi-steer session may be identified with a separate identifier called herein multi-steer Session ID (MSSID). In that case one or more MSSID may be associated with the UE. The MSCF may allocate a MSUID for the UE, for example, the first time the UE initiates a new session or when the UE registers with the MSCF. The MSCF may allocate a new MSSID when a new multi-steer session establishment is requested by the UE. The MSSID may be provided along with MSUID in the embodiments described herein (e.g., between UE and MSCF, MSCF and network functions or AF).

In some embodiments, once established, a multi-steer session termination may be initiated at any time by the first UE, the MSCF, or the network. A UE may request the MSCF to end its participation in each session providing a MSUID and/or MSSID. If the UE ending the session is the first UE, then all PDU Sessions associated with the multi-steer session may be released by the network. The first UE may provide an indication to release all PDU Sessions or release its PDU Session while maintaining others. If the participant UE is not the first UE, then the PDU Session of that participant UE may be released by the network (while the other PDU Sessions may be maintained). If the session for the primary or first UE is released, then the MSCF may pass attributes related to PDU session for the primary UE to the other UEs.

The MSCF may request the network (e.g., request removal of MSUID/MSSID from UDM) to terminate a session providing a MSUID and/or MSSID (e.g., upon UE request). The AMF/SMF(s) may be notified by the UDM of termination of the multi-steer session (e.g., upon MSCF request, multi-steer subscription data update). The MSCF may indicate the release of all PDU Sessions associated with the multi-steer session or only that of a UE (e.g., first UE or other UE). Alternatively, the first UE or the primary UE may request, upon establishment of the session, that the MSCF that upon release of a session, the MSCF releases all session, a subset of session, or only the session for a specific UE be released by the MSCF.

If the multi-steer session termination is initiated (e.g., triggered by UE and/or MSCF), the SMF may be notified (e.g., by UDM or AMF or MSCF) to release all PDU Sessions associated with the multi-steer session (e.g., indicating the MSUID/MSSID). If the session termination is initiated by a participant UE other than the first UE, the SMF of the participant UE may be notified to release the PDU Session of the participant UE associated with the multi-steer session. In that case, the SMF may instruct the UPF to adapt the data flows and steering accordingly (e.g., PMF indication to active UEs to start or resume transmission).

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke means-plus-function claim format, and any claim without the terms “means for” is not so intended.

What is claimed is:

1. A node of a core network (CN) for establishing a multi-steer protocol data unit (PDU) session for a first user equipment (UE) and a second UE, the node comprising at least one processor configured to:
determine a multi-steer identification (ID) for the first UE;
receive a PDU session request from the second UE, wherein the PDU session request indicates a multi-steer session type for the second UE;
retrieve the multi-steer ID for the first UE based on receiving the PDU session request from the second UE;
associate the PDU session request from the second UE with a session management function (SMF) of the CN based on the multi-steer ID; and
send a request to establish the multi-steer PDU session for the second UE using the SMF.

2. The node of claim 1, wherein to associate the PDU session request with the SMF is further based on determining whether a previously-established PDU session exists for the first UE, wherein the previously-established PDU session was established based on the multi-steer ID.

3. The node of claim 2, wherein if the previously-established PDU session exists, then to associate the PDU session request with the SMF comprises associating the PDU session request with an SMF of the previously-established PDU session for the first UE, wherein the SMF is the SMF of the previously-established PDU session.

4. The node of claim 2, wherein if the previously-established PDU session does not exist, then to associate the PDU session request with the SMF comprises selecting the SMF from among a plurality of available SMFs based on the multi-steer ID.

5. The node of claim 1, wherein to determine the multi-steer ID is further based on at least one of a subscription identifier of the first UE or of the second UE, at least one rule for communicating with the first UE or the second UE, a CN function ID, a PDU session ID, or an indication of which UE, among at least the first UE and the second UE, is a primary UE.

6. The node of claim 1, wherein to determine the multi-steer ID comprises attempting to retrieve the multi-steer ID from a function of the CN.

7. The node of claim 6, wherein to determine the multi-steer ID further comprises, in response to a failed attempt to retrieve the multi-steer ID, generating the multi-steer ID for the first UE based on retrieving an ID associated with the first UE.

8. The node of claim 1, wherein to retrieve the multi-steer ID comprises communicating with at least one other node of the CN.

9. The node of claim 1, wherein the at least one processor is further configured to determine, based on the multi-steer ID, how to route information that is communicated between the first UE, the second UE, and the SMF, wherein the information comprises first information from the first UE and second information from the second UE.

10. The node of claim 1, wherein the at least one processor is further configured to receive a registration request from the second UE, wherein the registration request further indicates the multi-steer session type of the second UE.

11. A method for establishing a multi-steer protocol data unit (PDU) session for a first user equipment (UE), the method performed by at least one processor of a node of a core network (CN), the method comprising:
determining a multi-steer identification (ID) for the first UE;
receiving a PDU session request from a second UE, wherein the PDU session request indicates a multi-steer session type for the second UE;
retrieving the multi-steer ID for the first UE based on receiving the PDU session request from the second UE;
associating the PDU session request from the second UE with a session management function (SMF) of the CN based on the multi-steer ID; and
sending a request to establish the multi-steer PDU session for the second UE using the SMF.

12. The method of claim 11, wherein associating the PDU session request with the SMF is further based on determining whether a previously-established PDU session exists for the first UE, wherein the previously-established PDU session was established based on the multi-steer ID.

13. The method of claim 12, wherein if the previously-established PDU session exists, then associating the PDU session request with the SMF comprises associating the PDU session request with an SMF of the previously-established PDU session for the first UE, wherein the SMF is the SMF of the previously-established PDU session.

14. The method of claim 12, wherein if the previously-established PDU session does not exist, then associating the PDU session request with the SMF comprises selecting the SMF from among a plurality of available SMFs based on the multi-steer ID.

15. The method of claim 11, wherein determining the multi-steer ID is further based on at least one of a subscription identifier of the first UE or of the second UE, at least one rule for communicating with the first UE or with the second UE, a CN function ID, a PDU session ID, or an indication of which UE, among at least the first UE and the second UE, is a primary UE.

16. The method of claim 11, wherein determining the multi-steer ID comprises attempting to retrieve the multi-steer ID from a function of the CN.

17. The method of claim 16, wherein determining the multi-steer ID further comprises, in response to a failed attempt to retrieve the multi-steer ID, generating the multi-steer ID for the first UE based on retrieving an ID associated with the first UE.

18. The method of claim 11, wherein retrieving the multi-steer ID comprises communicating with at least one other node of the CN.

19. The method of claim 11, further comprising determining, based on the multi-steer ID, how to route information that is communicated between the first UE, the second UE, and the SMF, wherein the information comprises first information from the first UE and second information from the second UE.

20. The method of claim 11, further comprising receiving a registration request from the second UE, wherein the registration request further indicates the multi-steer session type of the second UE.
